(19) United States
(12) Patent Application Publication
(10) Pub. No.: US 2017/0351243 A1
(43) Pub. Date: Dec. 7, 2017

(54) ROBOT MAINTENANCE ASSIST DEVICE AND METHOD

(71) Applicant: KAWASAKI JUKOGYO KABUSHIKI KAISHA, Kobe-shi, Hyogo (JP)

(72) Inventors: Hiromi SAWADA, Kobe-shi (JP); Masato YOSHIMURA, Akashi-shi (JP); Tomoya SHIMIZU, Kobe-shi (JP)

(73) Assignee: KAWASAKI JUKOGYO KABUSHIKI KAISHA, Kobe-shi, Hyogo (JP)

(21) Appl. No.: 15/537,461

(22) PCT Filed: Nov. 30, 2015
(86) PCT No.: PCT/JP2015/083652

§ 371 Date: Jun. 19, 2017

(30) Foreign Application Priority Data
Dec. 19, 2014 (JP) 2014-257004
Jun. 30, 2015 (JP) 2015-131422

(51) Int. Cl. G05B 19/4065

(52) U.S. Cl. CPC G05B 19/4065; G05B 2219/50197

(57) ABSTRACT

This device includes an acquired data storing unit for storing acquired data about a current command value of a servo motor configuring a robot drive system; a tendency diagnosis unit for diagnosing a future changing tendency of the current command value based on the data of the current command value stored in the acquired data storing unit; and a life determining unit for determining a term until the current command value reaches a previously set value based on the future changing tendency of the current command value acquired by the tendency diagnosis unit. Thus, a residual life of the robot drive system can be accurately predicted.

### TECHNICAL FIELD

The present invention relates to a robot maintenance assist device and method for predicting a residual life of a drive system of a robot so as to assist maintenance of the robot.

### BACKGROUND ART

In an industrial robot, due to its long term use, deterioration (for example, wear of reduction gear) occurs in apparatus configuring a robot drive system for driving a robot arm and a robot external axis, and thereby operation accuracy of the robot declines. Further, if such a state is left untouched, the apparatus configuring the robot drive system is broken and the robot breaks down.

In the industrial robot installed in a production line, the entire production line is stopped when the robot breaks down and productivity declines, which interferes with a production planning. Therefore, there is a market demand that preventive maintenance is performed before the breakdown of the robot so as to prevent the breakdown beforehand.

In order to meet this market demand, a conceivable method is for example to estimate a residual life of the apparatus based on a design life of the apparatus (such as a reduction gear) configuring the robot drive system and operation time of the robot up to the present time.

However, since a robot operation condition supposed when determining the design life of the apparatus and a robot operation condition in an actual work are sometimes significantly different, the method to estimate the residual life of the apparatus based on the design life of the apparatus and the operation time of the robot up to the present time has difficulty in maintaining accuracy of its estimation value.

In contrast, for example Patent Document 1 proposes a technique of collecting data of a robot controller in the actual work via a communication line and performing failure diagnosis and maintenance based on the collected data. (Patent Document 1).

### CITATION LIST

### Patent Document

[Patent Document 1] Japanese Patent Application Laid-Open No. 2007-190663

### SUMMARY OF INVENTION

### Objects to be Achieved by the Invention

However, in the above-mentioned conventional technique, necessity of maintenance (parts replacement and the like) at the present time can be determined based on the data at the present time, while, when the maintenance at the present time is determined to be unnecessary, period (timing) when maintenance is needed in the future cannot be specified.

Thus, in the conventional technique, there is a problem that previously planning a work schedule regarding maintenance of the robot with a spare time is difficult, and as result, performing maintenance of the robot in a timely manner is difficult.

The present invention is made considering the above-mentioned problem of the conventional technique, and its object is to provide a robot maintenance assist device and method capable of accurately predicting a residual life of a robot drive system.

### Means for Achieving the Objects

In order to achieve the objects above, a first aspect of the present invention is a robot maintenance assist device for predicting a life of a drive system of a robot so as to assist a maintenance, comprising: an acquired data storing unit for storing an acquired data about a current command value of a servo motor configuring the drive system of the robot; a tendency diagnosis unit for diagnosing a future changing tendency of the current command value based on the data of the current command value stored in the acquired data storing unit; and a life determining unit for determining a term until the current command value reaches a previously set value based on the future changing tendency of the current command value acquired by the tendency diagnosis unit.

A second aspect of the present invention is that, in the first aspect, the acquired data storing unit stores data about a plurality of the current command values about a plurality of the servo motors configuring the drive system of the robot, and the robot maintenance assist device further comprises an object data select unit for selecting the current command value to be diagnosed by the tendency diagnosis unit from the plurality of current command values.

A third aspect of the present invention is that, in the first or second aspect, the tendency diagnosis unit has a function of making a display unit display a prediction line representing the future changing tendency of the current command value as a graph.

A fourth aspect of the present invention is that, in the third aspect, the life determining unit is configured to determine a time point corresponding to an intersecting point of the prediction line displayed in the graph and a reference line set in the graph as a predicted life.

A fifth aspect of the present invention further comprises, in any one of the first to fourth aspects, a diagnostic item select unit for selecting a diagnostic item of the current command value to be diagnosed by the tendency diagnosis unit from an I2 monitor, a DUTY, and a peak current.

A sixth aspect of the present invention further comprises, in any one of the first to fifth aspects, a set value change unit for changing a set value used upon a diagnosis in the tendency diagnosis unit.

A seventh aspect of the present invention is that, in any one of the first to sixth aspects, the set value used upon a diagnosis in the tendency diagnosis unit includes at least one of a threshold value regarding the current command value, the number of object data days from a current date, the number of days from the current date up to a determination date, and the lowest number of data used for a diagnostic operation.

An eighth aspect of the present invention is that, in any one of the first to seventh aspects, the tendency diagnosis unit is configured to perform a diagnosis based on only the current command value during an operation of the robot.

In order to achieve the objects above, a ninth aspect of the present invention is a robot maintenance assist device for predicting a life of a drive system of a robot so as to assist a maintenance, comprising: an acquired data storing unit for storing an acquired data about a current command value of a servo motor configuring the drive system of the robot; a tendency diagnosis unit for diagnosing a future changing tendency of the current command value based on the data of the current command value stored in the acquired data storing unit; a life determining unit for determining a term until the current command value reaches a previously set value based on the future changing tendency of the current command value acquired by the tendency diagnosis unit; and a display unit for acquiring at least one of a diagnosis result of the tendency diagnosis unit and a determination result of the life determining unit via a communication network and displaying the same.

Further, the ninth aspect of the present invention may be combined with any of or a plurality of the above-stated first to eighth aspects of the present invention.

In order to achieve the objects above, a tenth aspect of the present invention is a robot maintenance assist method for predicting a life of a drive system of a robot so as to assist a maintenance, comprising: an acquired data storing process for storing an acquired data about a current command value of a servo motor configuring the drive system of the robot; a tendency diagnosis process for diagnosing a future changing tendency of the current command value based on the data of the current command value stored by the acquired data storing process; and a life determining process for determining a term until the current command value reaches a previously set value based on the future changing tendency of the current command value acquired by the tendency diagnosis process.

An eleventh aspect of the present invention is that, in the tenth aspect, in the acquired data storing process, the data about a plurality of the current command values about a plurality of the servo motors configuring the drive system of the robot is stored, and the robot maintenance assist method further comprises an object data select process for selecting the current command value to be diagnosed in the tendency diagnosis process from the plurality of current command values.

A twelfth aspect of the present invention is that, in the tenth or eleventh aspect, in the tendency diagnosis process, a prediction line representing the future changing tendency of the current command value is displayed as a graph on a display unit.

A thirteenth aspect of the present invention is that, in the twelfth aspect, in the life determining process, a time point corresponding to an intersecting point of the prediction line displayed in the graph and a reference line set in the graph is determined as a predicted life.

A fourteenth aspect of the present invention further comprises, in any one of the tenth to thirteenth aspects, a diagnostic item select process for selecting a diagnostic item of the current command value to be diagnosed by the tendency diagnosis unit from an I2 monitor, a DUTY, and a peak current.

A fifteenth aspect of the present invention further comprises, in any one of the tenth to fourteenth aspects, a set value change process for changing a set value used upon a diagnosis in the tendency diagnosis unit.

A sixteenth aspect of the present invention is that, in any one of the tenth to fifteenth aspects, the set value used upon a diagnosis in the tendency diagnosis process includes at least one of a threshold value regarding the current command value, the number of object data days from a current date, the number of days from the current date up to a determination date, and the lowest number of data used for a diagnostic operation.

A seventeenth aspect of the present invention is that, in any one of the tenth to sixteenth aspects, in the tendency diagnosis process, a diagnosis is performed based on only the current command value during an operation of the robot.

### Effect of the Invention

According to the present invention, a robot maintenance assist device and method capable of accurately predicting a residual life of a robot drive system can be provided.

### BRIEF DESCRIPTION OF THE DRAWINGS

FIG. 1 is a block diagram illustrating a schematic configuration of a robot maintenance assist device according to one embodiment of the present invention.

FIG. 2 is a figure illustrating an object data used in the robot maintenance assist device in FIG. 1.

FIG. 3 is a figure illustrating set items used in the robot maintenance assist device in FIG. 1.

FIG. 4 is a figure illustrating each item of a trend graph prepared in the robot maintenance assist device in FIG. 1.

FIG. 5 is a figure illustrating an example of the trend graph prepared in the robot maintenance assist device in FIG. 1.

FIG. 6 is a flow chart illustrating a method of predicting a residual life of a robot drive system using the robot maintenance assist device in FIG. 1.

### EMBODIMENT OF THE INVENTION

Hereunder, a robot maintenance assist device according to one embodiment of the present invention will be described referring to the drawings.

First of all, a schematic configuration of a robot which is an object of the robot maintenance assist device according to this embodiment will be described. The robot comprises a robot arm and a robot drive system for driving this robot arm and an external axis of the robot.

The robot drive system has a servo motor generating drive force, a reduction gear transmitting drive force from the servo motor to the robot arm and the robot external axis, and an encoder detecting a position of the servo motor. The robot drive system is controlled by a servo control system including a position loop, a velocity loop, and a current loop.

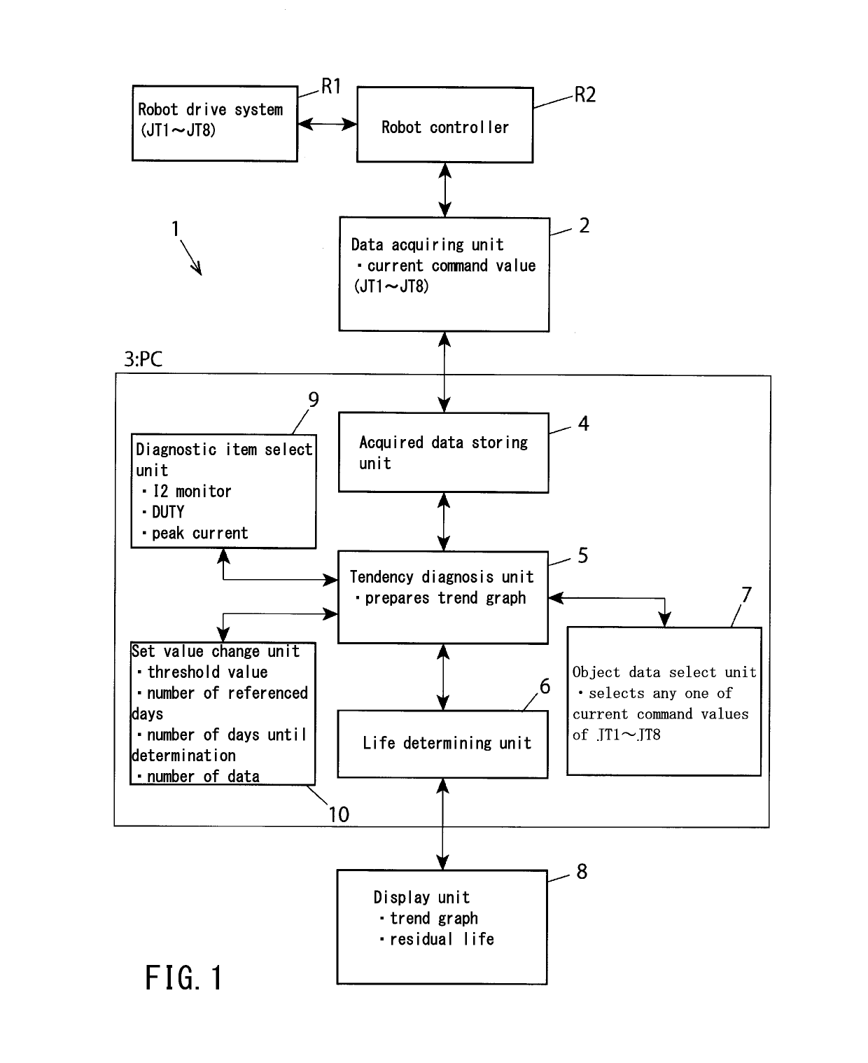

The robot which is an object of the robot maintenance assist device according to this embodiment comprises a robot drive system R1 having eight drive axes JT1˜JT8 as illustrated in FIG. 1, and this robot drive system R1 is controlled by a robot controller R2.

Further, a robot maintenance assist device 1 according to this embodiment is a device for predicting life of the robot drive system R1 so as to assist maintenance.

As illustrated in FIG. 1, the robot maintenance assist device 1 comprises a data acquiring unit 2 for acquiring data about current command value of each servo motor corresponding to each drive axis JT1˜JT8 of the robot drive system R1.

As for data acquisition by the data acquiring unit 2, data may be acquired from the robot controller R2 via a communication line such as internet or data may be directly acquired from the robot controller R2 by connecting a substrate for data acquisition to the robot controller R2.

Data about current command value acquired by the data acquiring unit 2 is sent to an acquired data storing unit 4 configured in a PC 3 and stored there. The acquired data storing unit 4 stores data about a plurality of current command values related to a plurality of servo motors configuring the robot drive system R1.

The robot maintenance assist device 1 further comprises a tendency diagnosis unit 5 for diagnosing future changing tendency of current command values of the servo motors. This tendency diagnosis unit 5 diagnoses future changing tendency of current command values based on data about current command values stored in the acquired data storing unit 4. The diagnosis result can be output as a trend graph, for example.

The robot maintenance assist device 1 further comprises a life determining unit 6 for determining life of the robot drive system R1. This life determining unit 6 determines a term until a current command value of the servo motor configuring the robot drive system R1 reaches a previously set value based on the future changing tendency of current command values acquired by the tendency diagnosis unit 5.

The robot maintenance assist device 1 further comprises an object data select unit 7 for selecting a current command value to be diagnosed by the tendency diagnosis unit 5 from a plurality of current command values corresponding to each drive axis JT1˜JT8. Thus, the object data select unit 7 can select a drive axis JT1˜JT8 whose residual life should be determined.

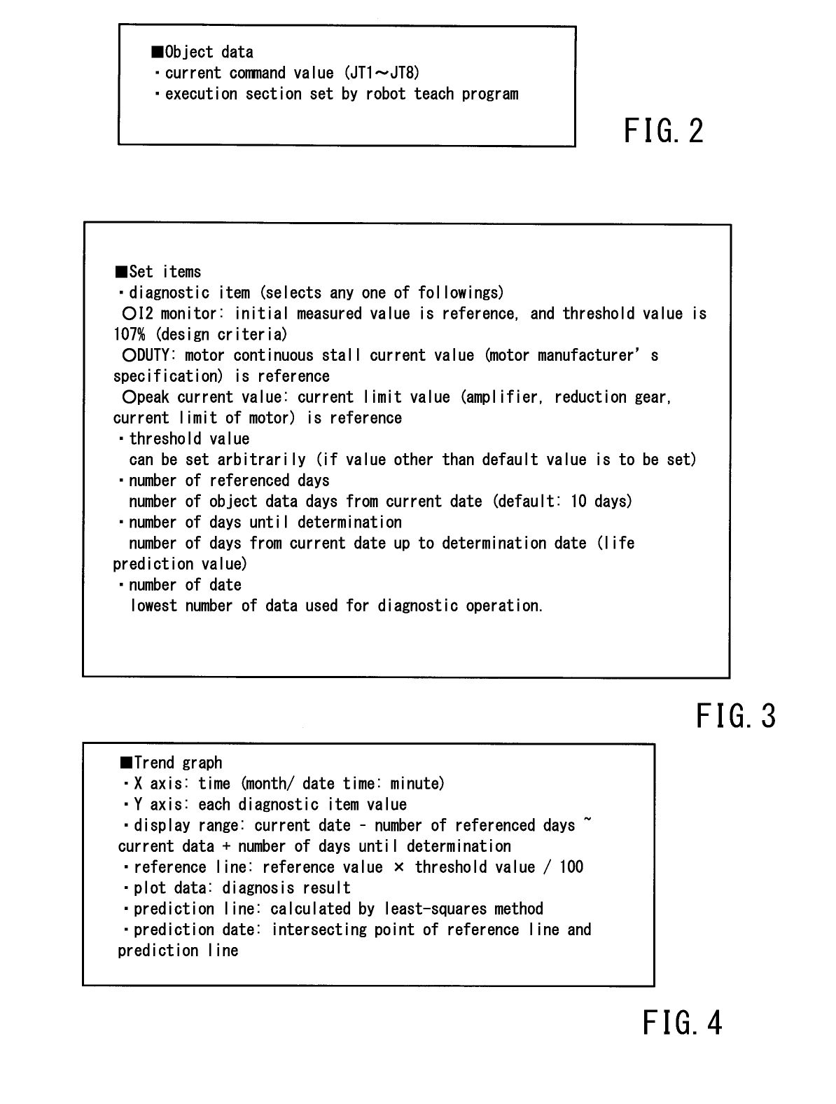

As illustrated in FIG. 2, the object data selected by the object data select unit 7 is data in an execution section set by a robot teach program. Thus, only data about current command values during robot operation is to be diagnosed and data during robot stopping is not to be diagnosed. Thereby, accuracy of determination of residual life can be improved.

The tendency diagnosis unit 5 of the robot maintenance assist device 1 has a function of making a display unit 8 display a prediction line representing future changing tendency of a current command value as a graph (trend graph). Further, the life determining unit 6 is configured to determine a time point corresponding to an intersecting point of a prediction line displayed in the graph and a reference line set in the graph as a predicted life.

The robot maintenance assist device 1 further comprises a diagnostic item select unit 9 for selecting a diagnostic item of current command value to be diagnosed by the tendency diagnosis unit 5 from an I2 monitor, duty (DUTY), and peak current.

As illustrated in FIG. 3, in the I2 monitor, an initial measured value is a reference and a threshold value is 107% (design criteria). In the DUTY, a motor continuous stall current value (motor manufacturer's specification) is a reference. In the peak current value, a current limit value (amplifier, reduction gear, current limit of motor) is a reference.

Additionally, the robot maintenance assist device 1 comprises a set value change unit 10 for changing a set value used upon the diagnosis in the tendency diagnosis unit 5. As illustrated in FIG. 3, set values used upon the diagnosis in the tendency diagnosis unit 5 include a threshold value regarding the current command value, the number of object data days (number of referenced days) from a current date, the number of days (number of days until determination) from the current date up to a determination date (life prediction value), and the lowest number of data used for diagnostic operation.

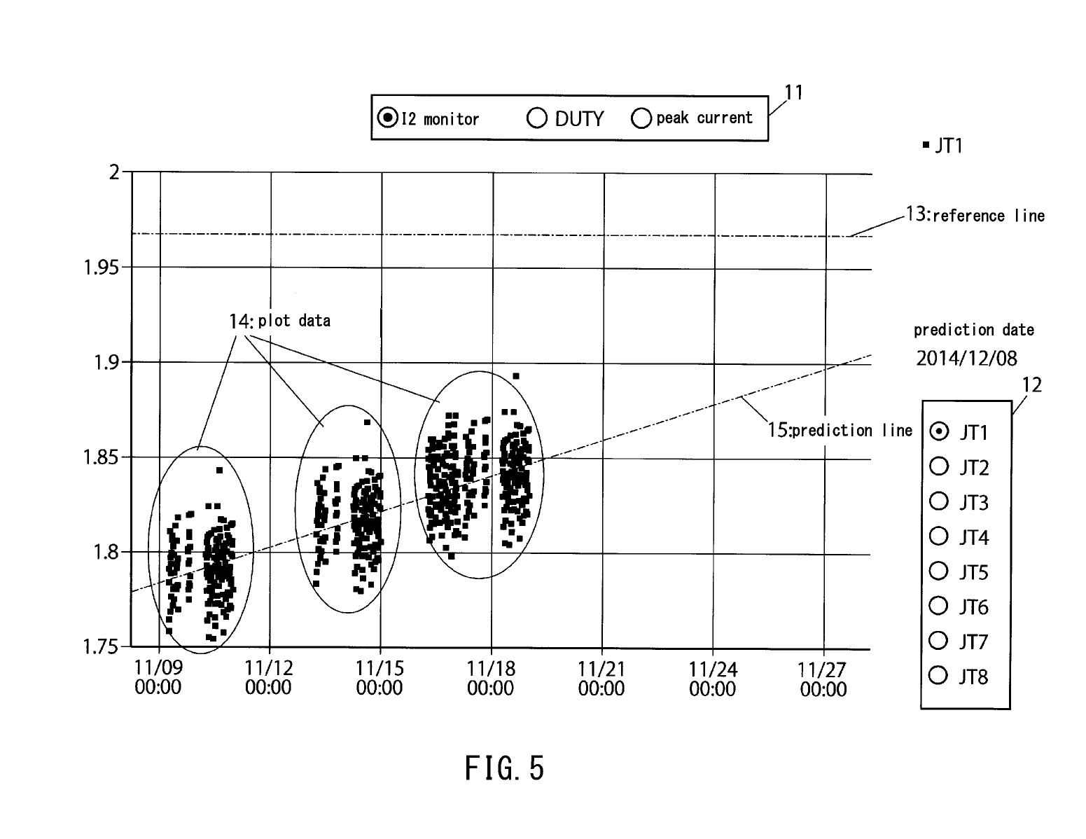

A graph displayed in the display unit 8 of the robot maintenance assist device 1 includes items shown in FIG. 4 and an example of the graph is illustrated in FIG. 5. In FIG. 5, in a case when the I2 monitor is selected in a diagnostic item select portion 11, a diagnosis result of the current command value regarding the servo motor corresponding to the drive axis JT1 selected in an object data select portion 12 is illustrated.

A X axis (horizontal axis) of the graph illustrated in FIG. 5 represents date and time when the data of the current command value is acquired and a Y axis (vertical axis) represents the current command value of the servo motor corresponding to the drive axis JT1, provided that the I2 monitor is a diagnostic item. The number of referenced days in the graph is 10 days which is a default. A reference line 13 to be a determination reference of a residual life is determined as the reference value * the threshold value/100.

In the graph, a prediction line 15 acquired by the least-squares method based on a plot data 14 of the current command value is shown. An intersecting point of this prediction line 15 and the reference line 13 is shown as a prediction date 16 of a residual life.

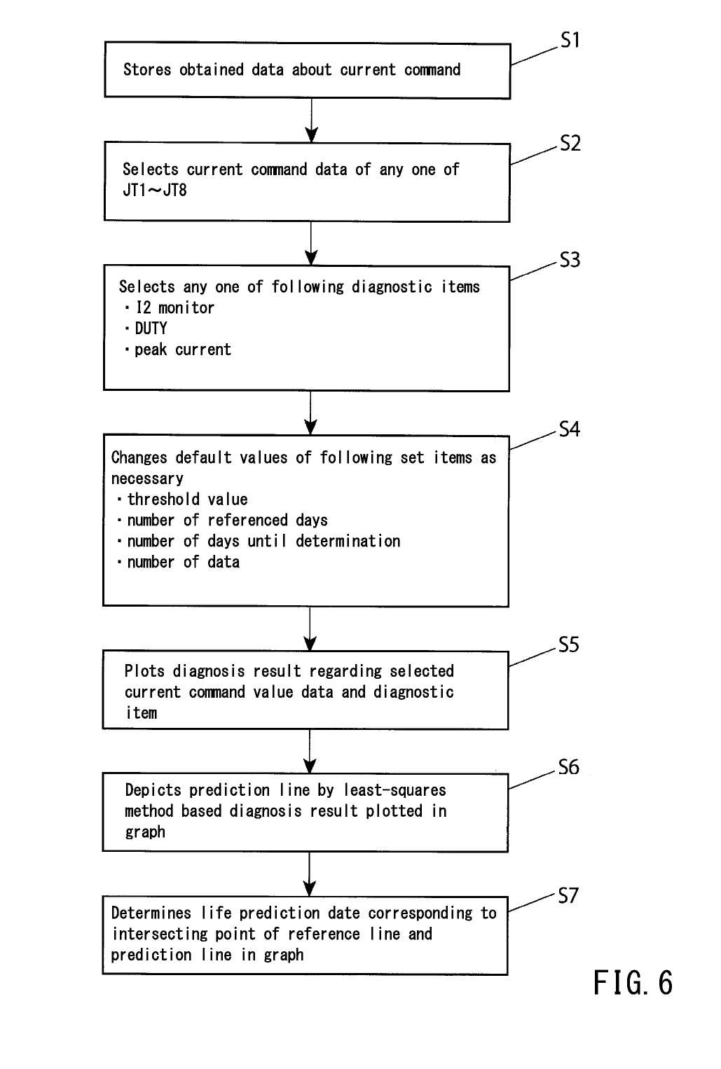

Next, a method of predicting life of the robot drive system R1 so as to assist maintenance of the robot using the above-mentioned robot maintenance assist device 1 will be described referring to FIG. 6.

First, data about the current command values of the servo motors corresponding to a plurality of drive axes JT1˜JT8 acquired by the data acquiring unit 2 is stored by the acquired data storing unit 4 (acquired data storing process S1). Subsequently, the current command value to be diagnosed is selected from a plurality of current command values corresponding to a plurality of drive axes JT1˜JT8 (object data select process S2).

Next, a diagnostic item is selected from the I2 monitor, DUTY, and peak current by the diagnostic item select unit 9 (diagnostic item select process S3). Further, default values of the threshold value, number of referenced days, number of days until determination, and number of data are changed by the set value change unit 10 as necessary (set value change process S4).

Next, diagnosis results regarding the selected current command value data and diagnostic items are plotted in a graph by the tendency diagnosis unit 5 (diagnosis result plot process S5). Subsequently, a prediction line is depicted by the least-squares method based the diagnosis results plotted in the graph (prediction line depicting process S6). The diagnosis result plot process S5 and the prediction line depicting process S6 configure a tendency diagnosis process for diagnosing future changing tendency of the current command value.

Next, the life determining unit 6 determines a term until the current command value reaches the previously set reference line 13 based on the future changing tendency of the current command value acquired in the tendency diagnosis process S5, S6 (life determining process S7). Thus, in the life determining process S7, an intersecting point of the prediction line 15 displayed in the graph in FIG. 5 and the reference line 13 set in the graph is determined as a predicted life.

As stated above, according to this embodiment, a residual life of the robot drive system R1 can be predicted at high accuracy based on the data of the current command value of the servo motor of the robot drive system R1. Thereby, maintenance of the robot can be performed in a timely manner, and stop time of the robot due to breakdown can be minimized so that decline in productivity of the production line where the robot is installed can be surely prevented.

Particularly, in this embodiment, the tendency diagnosis unit 5 performs diagnosis based on only the current command value during robot operation, and therefore prediction accuracy of residual life of the robot drive system R1 can be further enhanced.

As another embodiment of the present invention, in the above-stated configuration of the embodiment, a device connectable to the PC3 connected to the robot controller R2 via a communication network such as internet can be installed in addition to or instead of the display unit 8 connected to the robot controller R2.

A so-called smart device such as a tablet terminal, smartphone, and laptop PC is suitable for such a device. Alternatively, a common desktop PC also can be used. Thus, any device may be employed as long as it is connectable to the PC 3 via a communication network in a place away from the site where the robot is installed.

In the robot maintenance assist device and method according to this embodiment, the robot condition can be remotely confirmed even in a place away from the site where the robot is installed. Thereby, the maintenance work of the robot can be performed more properly and timely.

### DESCRIPTION OF REFERENCE NUMERALS

1 . . . robot maintenance assist device
2 . . . data acquiring unit
3 . . . PC
4 . . . acquired data storing unit
5 . . . tendency diagnosis unit
6 . . . life determining unit
7 . . . object data select unit
8 . . . display unit
9 . . . diagnostic item select unit
10 . . . set value change unit
11 . . . diagnostic item select portion
12 . . . object data select portion
13 . . . reference line of graph
14 . . . plot data
15 . . . prediction line of graph
16 . . . prediction date of residual life
R1 . . . robot drive system
R2 . . . robot controller
S1 . . . acquired data storing process
S2 . . . object data select process
S3 . . . diagnostic item select process
S4 . . . set value change process
S5 . . . diagnosis result plot process (tendency diagnosis process)
S6 . . . prediction line depicting process (tendency diagnosis process)
S7 . . . life determining process

1. A robot maintenance assist device for predicting a life of a drive system of a robot so as to assist a maintenance, comprising:
an acquired data storing unit for storing an acquired data about a current command value of a servo motor configuring the drive system of the robot;
a tendency diagnosis unit for diagnosing a future changing tendency of the current command value based on the data of the current command value stored in the acquired data storing unit; and
a life determining unit for determining a term until the current command value reaches a previously set value based on the future changing tendency of the current command value acquired by the tendency diagnosis unit.

2. The robot maintenance assist device according to claim 1,
wherein the acquired data storing unit stores data about a plurality of current command values about a plurality of servo motors configuring the drive system of the robot, and
wherein the robot maintenance assist device further comprises an object data select unit for selecting the current command value to be diagnosed by the tendency diagnosis unit from the plurality of current command values.

3. The robot maintenance assist device according to claim 1, wherein the tendency diagnosis unit has a function of making a display unit display a prediction line representing the future changing tendency of the current command value as a graph.

4. The robot maintenance assist device according to claim 3, wherein the life determining unit is configured to determine a time point corresponding to an intersecting point of the prediction line displayed in the graph and a reference line set in the graph as a predicted life.

5. The robot maintenance assist device according to claim 1, further comprising a diagnostic item select unit for selecting a diagnostic item of the current command value to be diagnosed by the tendency diagnosis unit from an I2 monitor, a DUTY, and a peak current.

6. The robot maintenance assist device according to claim 1, further comprising a set value change unit for changing a set value used upon a diagnosis in the tendency diagnosis unit.

7. The robot maintenance assist device according to claim 1, wherein the set value used upon a diagnosis in the tendency diagnosis unit includes at least one of a threshold value regarding the current command value, a number of object data days from a current date, a number of days from the current date up to a determination date, and a lowest number of data used for a diagnostic operation.

8. The robot maintenance assist device according to claim 1, wherein the tendency diagnosis unit is configured to perform a diagnosis based on only the current command value during an operation of the robot.

9. A robot maintenance assist device for predicting a life of a drive system of a robot so as to assist a maintenance, comprising:
an acquired data storing unit for storing an acquired data about a current command value of a servo motor configuring the drive system of the robot;
a tendency diagnosis unit for diagnosing a future changing tendency of the current command value based on the data of the current command value stored in the acquired data storing unit;
a life determining unit for determining a term until the current command value reaches a previously set value based on the future changing tendency of the current command value acquired by the tendency diagnosis unit; and
a display unit for acquiring at least one of a diagnosis result of the tendency diagnosis unit and a determination result of the life determining unit via a communication network and displaying the diagnosis result and/or the determination result.

10. A robot maintenance assist method for predicting a life of a drive system of a robot so as to assist a maintenance, comprising:
an acquired data storing process of storing an acquired data about a current command value of a servo motor configuring the drive system of the robot;
a tendency diagnosis process of diagnosing a future changing tendency of the current command value based on the data of the current command value stored by the acquired data storing process; and
a life determining process for determining a term until the current command value reaches a previously set value based on the future changing tendency of the current command value acquired by the tendency diagnosis process.

11. The robot maintenance assist method according to claim 10,
wherein, in the acquired data storing process, the data about a plurality of current command values about a plurality of servo motors configuring the drive system of the robot is stored, and
wherein the robot maintenance assist method further comprises an object data select process for selecting the current command value to be diagnosed in the tendency diagnosis process from the plurality of current command values.

12. The robot maintenance assist method according to claim 10, wherein, in the tendency diagnosis process, a prediction line representing the future changing tendency of the current command value is displayed as a graph on a display unit.

13. The robot maintenance assist method according to claim 12, wherein, in the life determining process, a time point corresponding to an intersecting point of the prediction line displayed in the graph and a reference line set in the graph is determined as a predicted life.

14. The robot maintenance assist method according to claim 10, further comprising a diagnostic item select process for selecting a diagnostic item of the current command value to be diagnosed by the tendency diagnosis process from an I2 monitor, a DUTY, and a peak current.

15. The robot maintenance assist method according to claim 10, further comprising a set value change process for changing a set value used upon a diagnosis in the tendency diagnosis process.

16. The robot maintenance assist method according to claim 10, wherein the set value used upon a diagnosis in the tendency diagnosis process includes at least one of a threshold value regarding the current command value, a number of object data days from a current date, a number of days from the current date up to a determination date, and a lowest number of data used for a diagnostic operation.

17. The robot maintenance assist method according to claim 10, wherein, in the tendency diagnosis process, a diagnosis is performed based on only the current command value during an operation of the robot.
